(19) United States
(12) Patent Application Publication
(10) Pub. No.: US 2017/0307178 A1
(43) Pub. Date: Oct. 26, 2017

(54) Outdoor Light and related methods

(71) Applicant: Auroralight, Inc., La Jolla, CA (US)

(72) Inventor: Michael P. Joye, Carlsbad, CA (US)

(21) Appl. No.: 15/497,019

(22) Filed: Apr. 25, 2017

Related U.S. Application Data
(60) Provisional application No. 62/327,366, filed on Apr. 25, 2016.

(51) Int. Cl. F21V 14/08; F21V 14/02; F21V 14/00; F21V 1/10; F21V 15/015; F21S 6/00

(52) U.S. Cl. CPC F21V 14/08; F21V 14/02; F21S 6/005; F21V 1/10; F21V 15/015; F21V 14/003

(57) ABSTRACT

Disclosed are outdoor lighting devices with multiple lighting sources and with structures that are configured to both (a) vary the intensity of the light source and (b) vary the direction of the light projected from the light source.

### CROSS-REFERENCE TO RELATED APPLICATIONS

This application claims the benefit and priority of U.S. Prov. Pat. App. Ser. No. 62/327,366 (filed Apr. 25, 2016) by Auroralight, Inc. for “Outdoor light, improved bi-pin LED light bulb, and related methods.” This provisional document is hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND AN INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of both outdoor lighting devices.

### Background of the Invention

Path lighting devices illuminate dark walkways by projecting light onto the surface of the walkway. Traditional path lighting devices have a single light emitting source that can only be projected downward toward the walkway surface in a single direction at a constant light intensity. These traditional path lighting devices with a single light source in a single direction are not always satisfactory because walkways can be non-linear and can be located adjacent to other objects, like signs or walls that should be lit in addition to the walkway. Furthermore, traditional path lighting devices with constant light intensity is neither suited to customization of the light intensity needs of one walkway over another nor suited to customization based on light intensity preferences of a user.

### SUMMARY OF THE INVENTION

In view of the foregoing, an object of this specification is to disclose path lighting devices with multiple lighting sources and with structures that are configured to both (a) vary the intensity of the light source and (b) vary the direction of the light projected from the light source. In one embodiment, the disclosed path lighting device is a tee-lamp comprising: a tee-joint defined by a left joint, a right joint that is coaxial to the left joint, and a center joint; a riser that is coupled to the center joint of the tee-joint; a first light housing for a first light source that is pivotally mounted to the left joint of the tee-joint so that light from the first light source may be radially projected in various directions around the co-axis of the left and right joints of the tee joint; a first shutter that is pivotally mounted to the first light housing so that the first shutter may be rotated to variously block any projections of light from the first light source; a second light housing for a second light source that is pivotally mounted to the right joint of the tee-joint so that light from the second light source may be radially projected in various directions around the co-axis of the left and right joints of the tee joint; a second shutter that is pivotally mounted to the second light housing so that the second shutter may be rotated to variously block any projections of light from the second light source. In one mode of use, the tee-lamp may have the first light housing rotated relative to the tee-joint so that light may be projected in a first direction from the first light source and second light housing rotated relative to the tee-joint so that light may be projected in a second direction from the second light source. In another mode of operation, intensity of light projected from the first and/or second light source may be varied via rotating the shutter relative to the first light housing to block projections of light from the first light source.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is an exploded view of a tee lamp;

FIG. 2 is front or back view of the tee lamp of FIG. 1;

FIG. 3 is a top view of the tee lamp of FIG. 1;

FIG. 4 is a bottom view of the tee lamp of FIG. 1;

FIG. 5 is a left side view of the tee lamp of FIG. 1;

FIG. 6 is a right side view of the tee lamp of FIG. 1;

FIG. 7 is front view of another embodiment of a tee lamp of FIG. 1;

FIG. 8 is back view of the tee lamp of FIG. 7;

FIG. 9 is a top view of the tee lamp of FIG. 7;

FIG. 10 is a bottom view of the tee lamp of FIG. 7;

FIG. 11 is a left side view of the tee lamp of FIG. 7;

FIG. 12 is a right side view of the tee lamp of FIG. 7;

FIG. 13 is a front dimensional view of the tee lamp of FIGS. 2 through 6;

FIG. 14 is a front dimensional view of the tee lamp of FIGS. 7 through 12;

FIG. 15 is an environmental view of the tee lamp of the earlier figures;

FIG. 16 is another environmental view of the tee lamp of the earlier figures;

FIG. 17 is yet another environmental view of the tee lamp of the earlier figures;

FIG. 18 is a diagram for adjusting the light intensity of light emitted from the tee lamp of the earlier figures;

FIG. 19 illustrates various mounting mechanisms for mounting the tee lamp of the earlier figures to a support surface;

FIG. 20 is a front surface of an embodiment of a tee lamp; and,

FIG. 21 is a front surface of another embodiment of a tee lamp.

In the figures, the following reference numerals refer to these parts:

1000—tee lamp;

1100—left light housing assembly;

1110—light housing;

1111—open end;

1112—set pin;

1113—track pin;

1120—lighting source;

1121—bolt;

1122—lens or cover;

1130—shutter;

1131—shutter track;

1132—pivot pin;

1200—right light housing assembly;

1210—light housing;

1211—open end;

1212—set pin;

1213—track pin;

1220—lighting source;

1221—bolt;

1222—lens or cover;

1230—shutter;

1231—shutter track;

1232—pivot pin;

1300—tee joint assembly;

1310—tee joint;

1311—left track;

1312—right track;

1313—left o-ring;

1314—right o-ring;

1315—Threaded nut;

1320—vertical joint;

1321—threaded head;

1322—o-ring;

1400—riser;

1500—mount assembly;

1510—threaded head;

1520—set pin;

1600—electrical wiring;

2000—walkway; and,

3000—wall.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed are path lighting devices with multiple lighting sources and with structures that are configured to both (a) vary the intensity of the light source and (b) vary the direction of the light projected from the light source. The preferred embodiment is a tee-lamp with independently rotating light housings that have independently rotating shutters. The housings rotate to adjust the projection line of a light source. The shutters rotate for adjusting the intensity of the light projected from the light source. The more specific details of the path lighting devices are disclosed in connection with the figures.

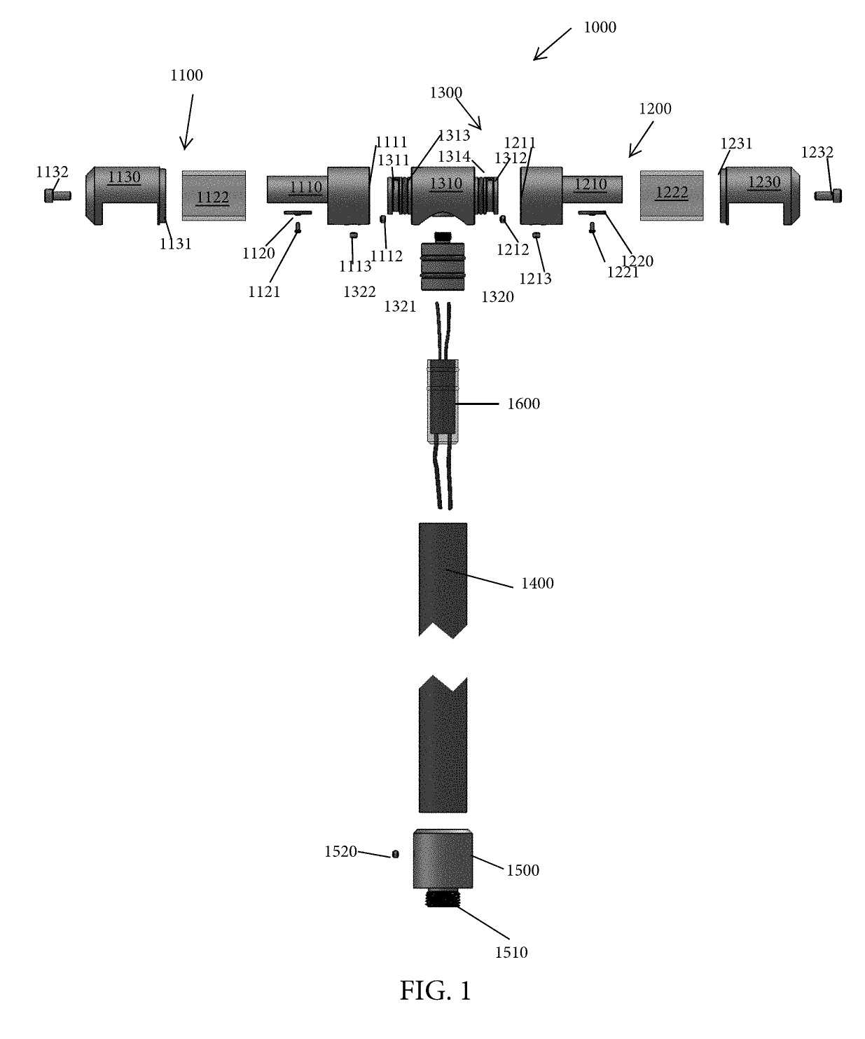

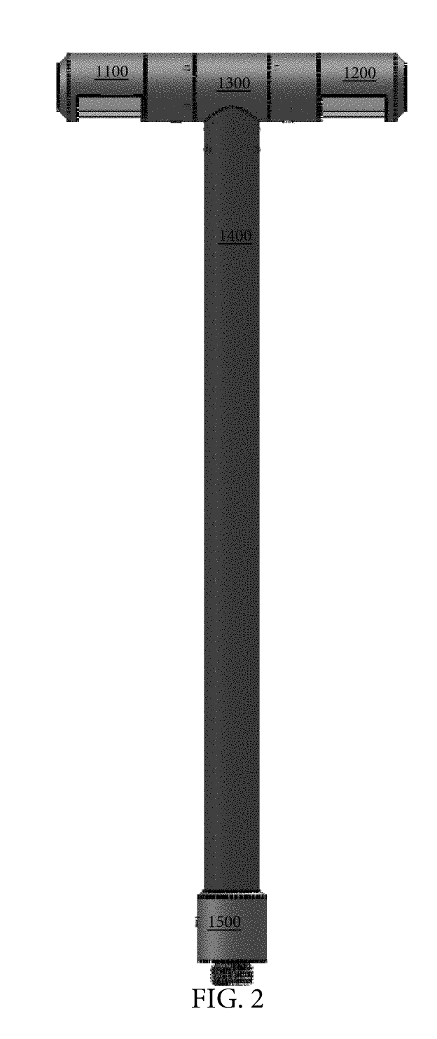

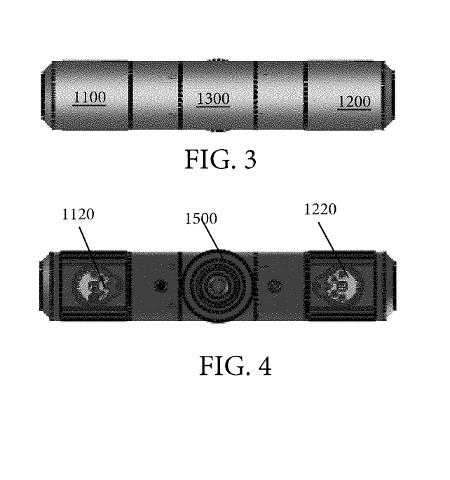

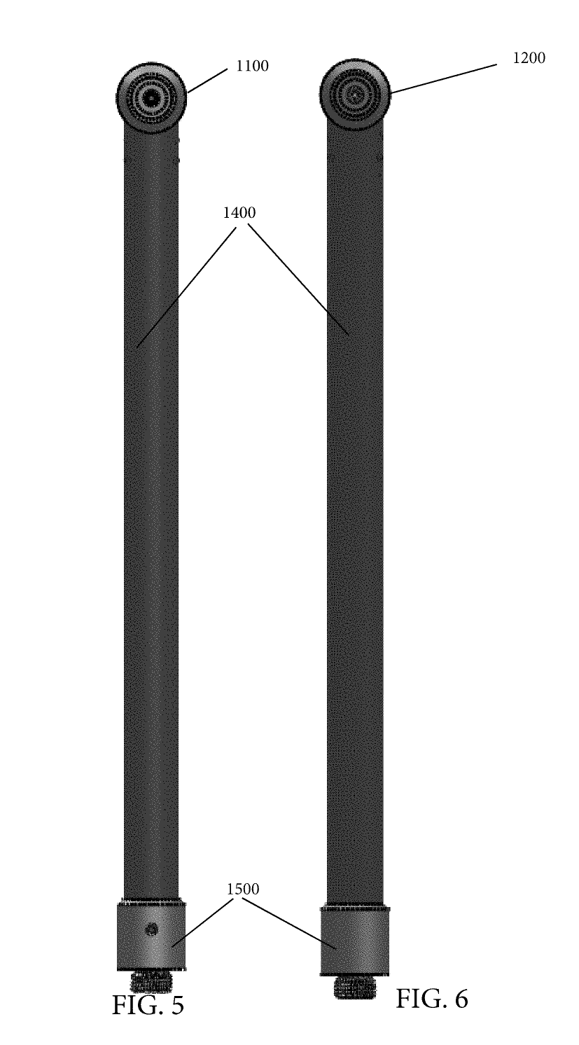

FIG. 1 is an exploded view of a tee lamp 1000. FIGS. 2 through 6 are respectively a front or back view, a top view, a bottom view, a left side view, and a right side view of the tee lamp 1000 of FIG. 1. As shown in those figures, the tee lamp 1000 is defined by a tee joint assembly 1300 that is: rotatably coupled on the left side to a left light housing assembly 1100; rotatably coupled on the right side to a right light housing 1200; and coupled to a riser 1400 at the center. In a preferred embodiment, the riser is coupled to a mount assembly 1500.

FIG. 1 shows the assembly of the tee-lamp 1000. As shown, the tee-joint assembly 1300 is defined by the tee joint 1310 that can features a threaded nut 1315 (not shown) capable of receiving the threaded head 1321 of the vertical joint. Suitably, the interface of the vertical joint 1320 is made water resistant via the including of an o-ring 1322 that interfaces with the tee-joint 1310 during coupling of the vertical and tee joints 1310, 1320. As shown, the tee-joint features a left track 1311 and a right track 1312 that define the rotation path of the left and right light housings 1110, 1210. Preferably, the left and right housings 1110, 1210 may have the respective ends of the joint inserted into the open ends 1111, 1211 of the housings 1110,1210 so that the tracks 1311, 1312 are positioned within the open ends 1111, 1211 of the housings 1110, 1210. In a preferred embodiment, the housings 1110, 1210 are maintained in the respective tracks 1311, 1312 by a respective guide pin 1113, 1213 that occupy the track during rotation of the housings 1110, 1210. Suitably, rotation of the housings 1110, 1210 can be locked via set pins 1112, 1212. In the depicted preferred embodiments, the light sources 1120, 1220 may be bolted in their respective place in the distal portion of the housings 1110, 1210 via bolts 1121, 1221. The lenses or covers 1122, 1222 can optionally be installed over the light source. Suitably, the distal ends of the housings 1110, 1210 may be provided to the shutters 1130, 1230 along the shutter tracks 1131, 1231. Suitably, the shutters 1130, 1230 are made rotatable relative to the housings 1110, 1210 via the pivot pins 1132, 1232. As shown, the electrical wiring 1600 may be provided through the tee joint assembly 1300 and into the riser 1400 and the riser installed on the vertical joint 1320. Finally, the mount 1500 may be installed with the threaded head 1510 positioned downward and held in place via set pin 1520.

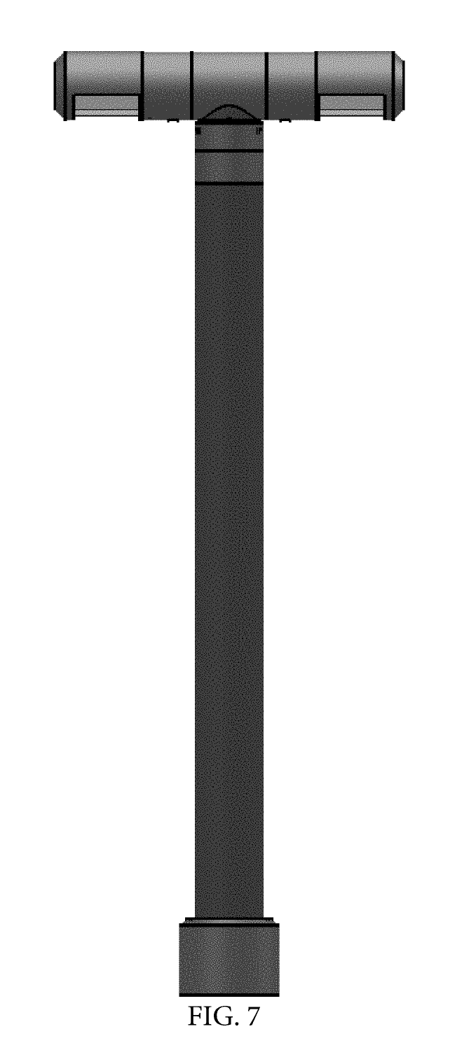

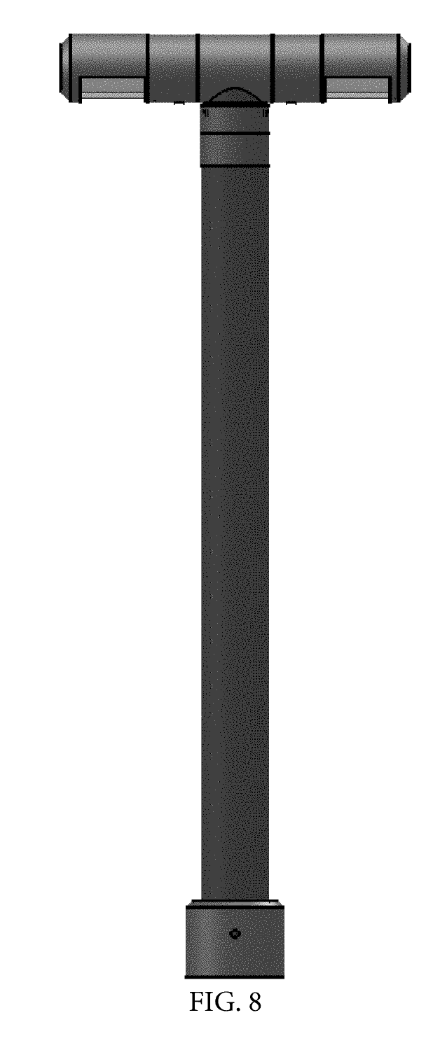

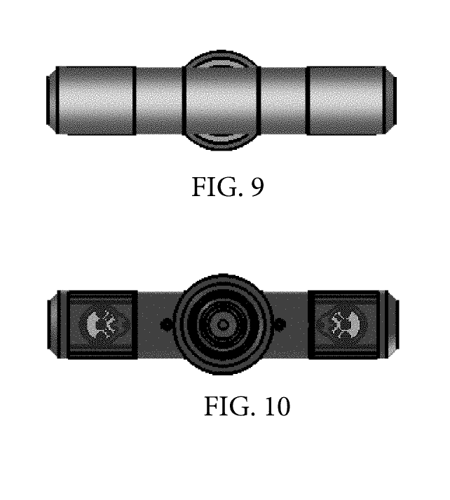

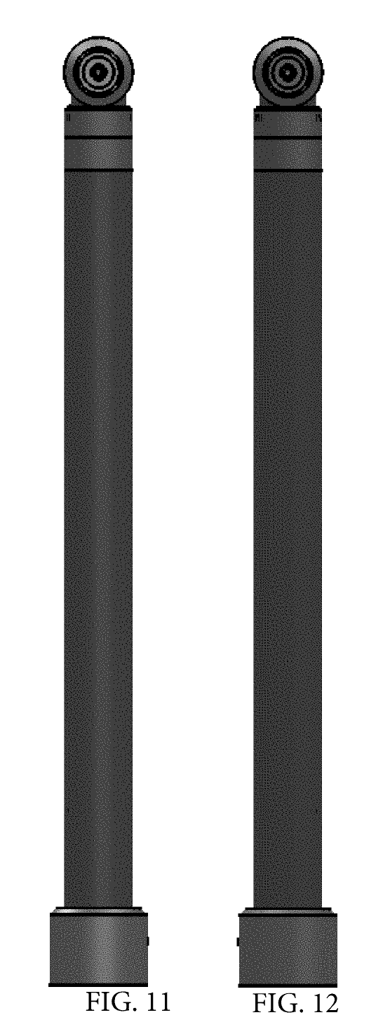

As discussed earlier, FIG. 1 is a view of a tee lamp 1000. FIGS. 7 through 12 are respectively a front view, a back view, a top view, a bottom view, a left side view, and a right side view of the tee lamp 1000. These embodiments function and are put together substantially as disclosed in connection with the earlier figures. One difference is that the riser in the second embodiment may suitably be telescopic in function.

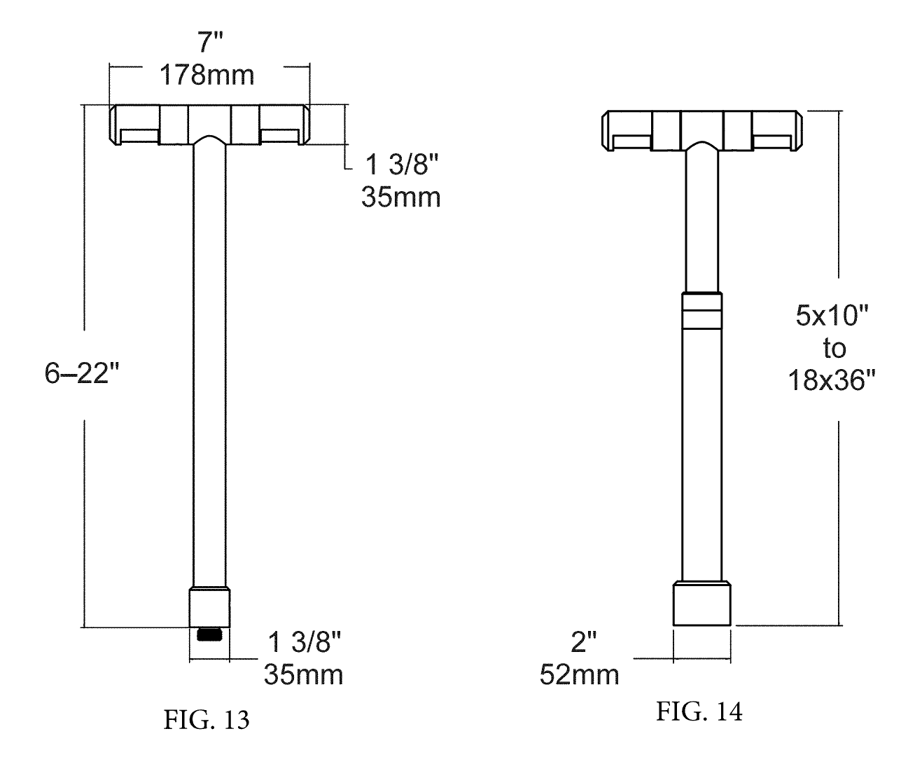

FIG. 13 is a front dimensional view of the tee lamp of FIGS. 1 through 6. FIG. 14 is a front dimensional view of the tee lamp of FIGS. 7 through 12. As shown in FIGS. 13 and 14, a preferred dimension of the first embodiment of the tee lamp is 6×22″×7″ by 1⅜″. In the telescopic version shown in FIG. 14, the height may vary from 5×10″ to 18×36″. Those of skill in the art will know well the dimensions capable of accommodating the disclosed path lighting devices after reading this disclosure.

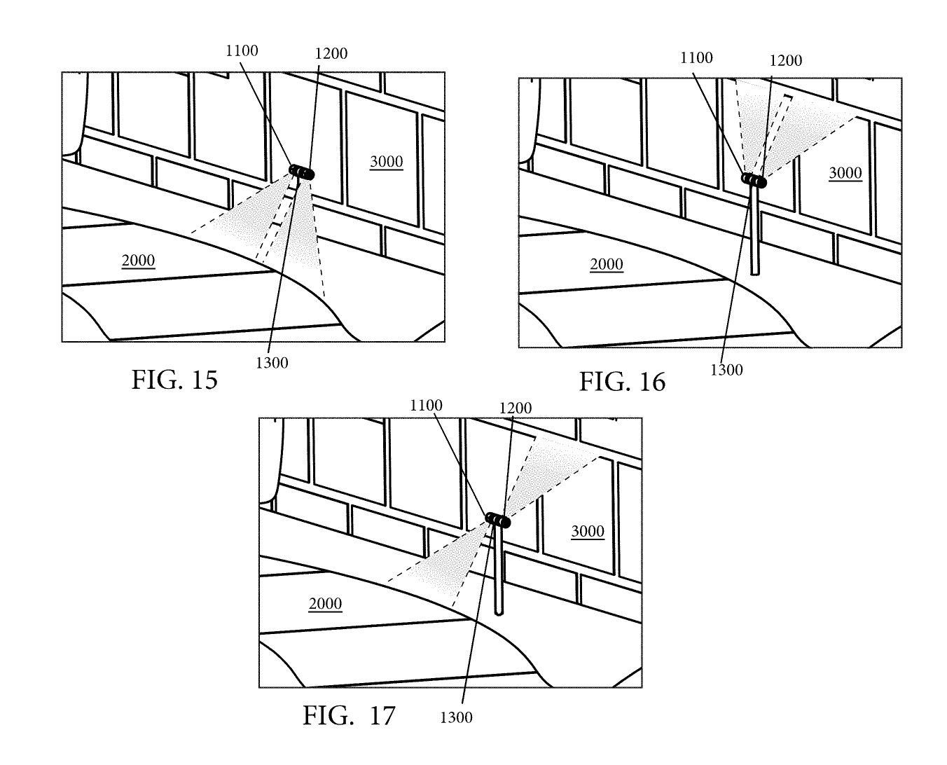

FIG. 15 is an environmental view of the tee lamp of the earlier figures, where the housing assemblies 1100, 1200 are rotated to light the surface of a walkway 2000. In particular, the light housing assemblies are rotated around the tee-joint assembly 1300 so that light is projected radially from the housings 1100, 1200 onto the walkway 2000. FIG. 16 is another environmental view of the tee lamp of the earlier figures. In this environment, the light housing assemblies are rotated around the tee-joint assembly 1300 so that light is projected radially from the housings 1100, 1200 onto the wall 3000. FIG. 17 is yet another environmental view of the tee lamp of the earlier figures. In this view, the left housing assembly 1100 is rotated so that light is projected onto the walkway 2000 while the right housing assembly 1200 is rotated so that light is projected onto the wall 3000.

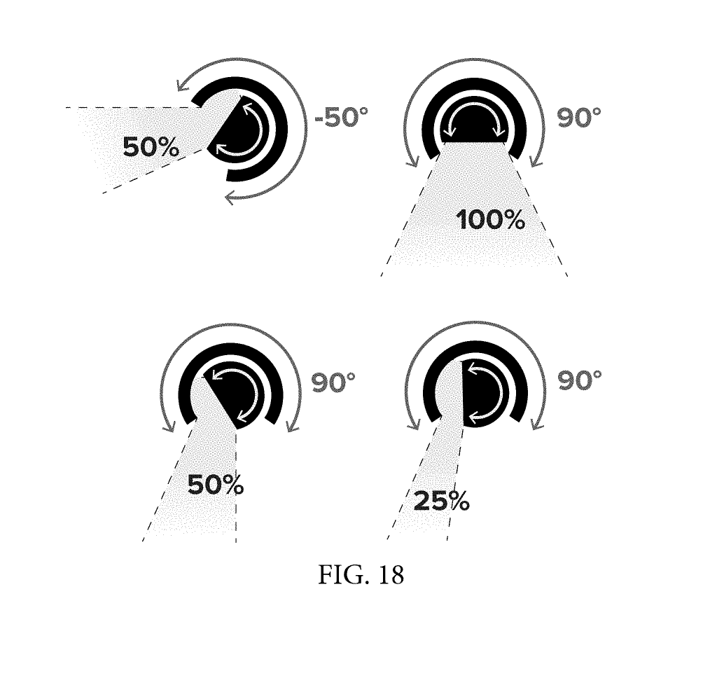

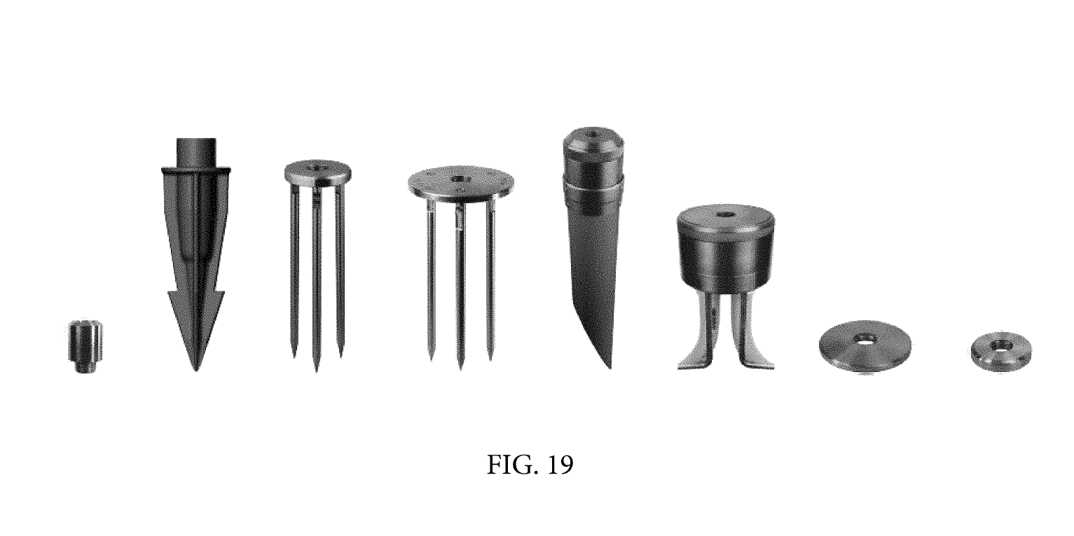

FIG. 18 is a diagram for adjusting the light intensity of light emitted from the tee lamp of the earlier figures. As shown, light intensity of light projected from the housing assemblies 1100 or 1200 can be reduced to: fifty percent full intensity by rotating the shutter 1130 or 1230 by negative fifty degrees relative to the housing 1110 or 1210; twenty-five percent full intensity by rotating the shutter 1130 or 1230 to a perpendicular orientation relative to the housing 1110 or 1210; one-hundred percent full intensity by rotating the shutter 1130 or 1230 to parallel orientation relative to the housing 1110, 1210. The light may be attenuated by fifty percent by moving the housing parallel to the housing with the light source directed in a different direction (see the bottom left configuration of FIG. 18). Suitably, manipulation of the light intensity may be similarly accomplished via rotation of the shutter in any direction as described above.

FIG. 19 illustrates various mounting mechanisms for mounting the tee lamp of the earlier figures to a support surface. As shown, the mounting mechanisms can attach to the threaded head 1510 of the mounting assembly. As shown, the mounting mechanisms can be any form of stake or bolting structure.

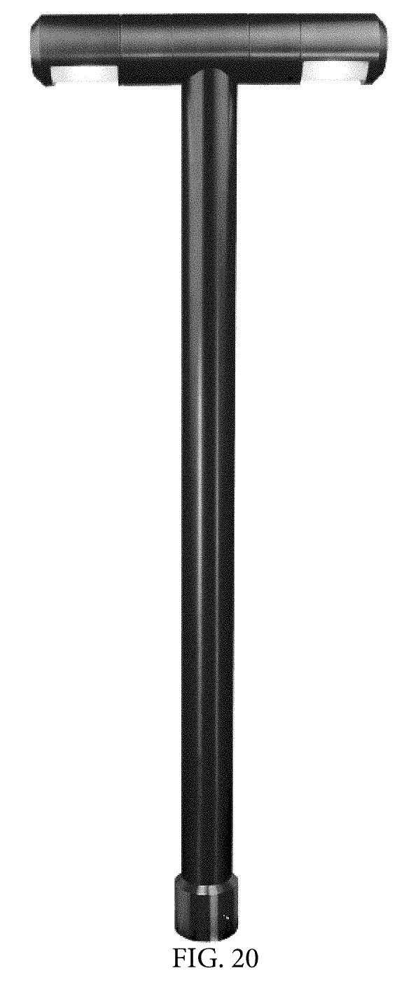

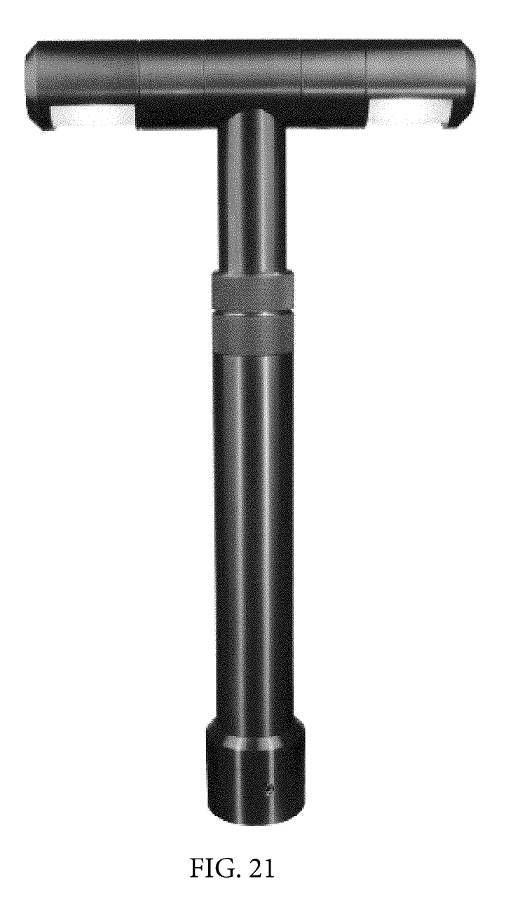

FIG. 20 is a front surface of an embodiment of a tee lamp. FIG. 21 is a front surface of another embodiment of a tee lamp. As shown, the various parts disclosed herein may be machined from copper or brass tubing or copper or brass rods. Any other metals, ceramics, composite materials, or plastics can be used to construct the path lighting devices disclosed herein.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. An outdoor lighting device comprising:
at least one lighting source; and,
at least one rotatable shutter that are configured to both (a) vary the intensity of the light source and (b) vary the direction of the light projected from the light source.

2. The outdoor lighting device of claim 1 further comprising:
wherein the lighting device is a tee lamp that is defined by a tee joint assembly that is:
rotatably coupled on the left side to a left light housing assembly, wherein said at least one light source is provided within the left light housing assembly, wherein said at least one shutter is rotatably provided around the left housing assembly, wherein the intensity of said at least one light source is variable via rotation of said at least one shutter relative to the left light housing assembly, and wherein the direction of light projected from the left light housing assembly is variable via rotation of the left light housing assembly relative to said tee joint assembly;
rotatably coupled on the right side to a right light housing assembly; and
coupled to a riser at the center.

3. The apparatus of claim 1 wherein:
light intensity of light projected from the housing assembly can be reduced by rotating the shutter relative to a housing for the light source.

4. A method for adjusting the light intensity of light emitted from a tee lamp:
where said tee lamp comprises:
at least one lighting source;
at least one rotatable shutter that is configured to both (a) vary the intensity of the light source and (b) vary the direction of the light projected from the light source; and,
where said method comprises the step of rotating said at least one shutter.

5. The method of claim 4 further comprising:
Wherein the lighting device is a tee lamp that is defined by a tee joint assembly that is:
rotatably coupled on the left side to a left light housing assembly, wherein said at least one light source is provided within the left light housing assembly, wherein said at least one shutter is rotatably provided around the left housing assembly, wherein the intensity of said at least one light source is variable via rotation of said at least one shutter relative to the left light housing assembly, and wherein the direction of light projected from the left light housing assembly is variable via rotation of the left light housing assembly relative to said tee joint assembly;
rotatably coupled on the right side to a right light housing assembly; and
coupled to a riser at the center.

6. A tee-lamp comprising:
a tee-joint defined by a left joint, a right joint that is coaxial to the left joint, and a center joint;
a riser that is coupled to the center joint of the tee-joint;
a first light housing for a first light source that is pivotally mounted to the left joint of the tee-joint so that light from the first light source may be radially projected in various directions around the co-axis of the left and right joints of the tee joint;
a first shutter that is pivotally mounted to the first light housing so that the first shutter may be rotated to variously block any projections of light from the first light source;
a second light housing for a second light source that is pivotally mounted to the right joint of the tee-joint so that light from the second light source may be radially projected in various directions around the co-axis of the left and right joints of the tee joint; and,
a second shutter that is pivotally mounted to the second light housing so that the second shutter may be rotated to variously block any projections of light from the second light source.
